(19) United States
(12) Patent Application Publication
(10) Pub. No.: US 2013/0031450 A1
(43) Pub. Date: Jan. 31, 2013

(54) SYSTEMS AND METHODS FOR PSYCHOGRAPHIC TITLING

(71) Applicant: Byron William Reese, Georgetown, TX (US)

(72) Inventor: Byron William Reese, Georgetown, TX (US)

(73) Assignee: DEMAND MEDIA, INC., Santa Monica, CA (US)

(21) Appl. No.: 13/560,834

(22) Filed: Jul. 27, 2012

Related U.S. Application Data
(60) Provisional application No. 61/512,886, filed on Jul. 28, 2011.

(51) Int. Cl. G06F 17/00

(52) U.S. Cl. 715/206

(57) ABSTRACT

Systems and methods are provided the for presentation of links to content to a user on webpages of a website where titles associated with the links are tuned to the user's psychographic variables. In one embodiment, a respective plurality of titles is generated for each of a plurality of content items. At least some titles are tagged with psychographic tags. When a user accesses content by selecting a link having a title that is tagged with one or more psychographic tags, the system stores a representation of such tags in association with the user. When additional links for recommended content are displayed to the user, the system selects titles for links to such content based on psychographic tags associated with the user and the titles.

### CROSS-REFERENCE TO RELATED APPLICATIONS

This application claims priority to U.S. Provisional Application No. 61/512,886 entitled “SYSTEMS AND METHODS FOR PSYCHOGRAPHIC TITLING,” filed Jul. 28, 2011, which is hereby incorporated by reference in its entirety.

This application is related to U.S. patent application Ser. No. 13/285,874, filed Oct. 31, 2011, entitled “SYSTEMS AND METHODS FOR RECOMMENDED CONTENT PLATFORM,” by Fink, et al., U.S. patent application Ser. No. 12/828,200, filed Jun. 30, 2010, entitled “RULE-BASED SYSTEM AND METHOD TO ASSOCIATE ATTRIBUTES TO TEXT STRINGS,” by Yehaskel, et al., U.S. patent application Ser. No. 12/877,935, filed Sep. 8, 2010, entitled “SYSTEMS AND METHODS FOR KEYWORD ANALYZER,” by Yehaskel, et al., and U.S. patent application Ser. No. 12/826,524, filed Jun. 29, 2010, entitled “SYSTEM AND METHOD FOR EVALUATING SEARCH QUERIES TO IDENTIFY TITLES FOR CONTENT PRODUCTION,” by Yehaskel, et al., the entire contents of which applications are incorporated by reference as if fully set forth herein.

### FIELD OF THE TECHNOLOGY

At least some embodiments disclosed herein relate to computer or data processing systems in general, and more particularly, but not limited to, presentation of a title or link to a user for selection of content by the user of a computing device for viewing or another action.

### BACKGROUND

Websites employ several means to bring visitors to the websites. They may advertise, get listed in search engines and directories, and otherwise promote their website. Once a website has attracted a visitor to the website, the website is often operated in a manner to try to entice the visitor to stay on the site and consume more Internet content. This may involve offering the visitor a choice of additional, recommended content to consume. Such content may relate to the content of the website, to content of special interest to the website visitor or may simply be of general interest

To limit the amount of “screen real estate” that this choice of additional content occupies, the visitor is often just shown the titles of the additional pieces of content in the hope that one of these titles will induce the visitor to click on the link to read the additional article. Thus, the selection of titles that are appealing to visitors is important to increase the likelihood that visitors will click on a title and consume the related content.

### BRIEF DESCRIPTION OF THE DRAWINGS

Various embodiments of the disclosure are illustrated by way of example and not limitation in the figures of the accompanying drawings in which like references indicate similar elements.

FIG. 1 shows an illustrative web page where a user is viewing a review of a movie.

FIG. 2 illustrates an embodiment of the relationship between content items and links to such content, and the titles to which they relate.

FIG. 3 shows a system to present content and titles (such as described above) to a user according to one embodiment.

FIG. 4 illustrates a high-level view of components of one embodiment of systems and networks for implementing a recommended content platform and provide recommended content services to websites and end-users.

FIG. 5 shows a block diagram of a data processing system that can be used in various embodiments.

FIG. 6 shows a block diagram of a user device according to one embodiment.

FIG. 7 illustrates an embodiment of a process for providing titles for content that are fine-tuned to users' pychodemographics.

### DETAILED DESCRIPTION

The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

For the purposes of this disclosure, “content” or “online content” should be understood to refer to various types of digital objects accessible over the Internet embodying the expression of one or more concepts that may be of interest to users. In one embodiment, content may take the form of text articles, such as news articles or topical articles relating to one or more topics. In one embodiment, content may take the form of multimedia objects, such as images, audio presentations, and audiovisual presentations relating to one or more topics.

For the purposes of this disclosure, “title” should be understood to represent a single sentence that could serve as a title for online content. Typically, a title conveys a single concept in a concise way that allows users to readily identify the nature of online content to which such titles are attached. In various embodiments, titles can be used for links to content. For the purposes of this disclosure, “link” should be understood to generally refer to data referring to content accessible, over a network, on one or more servers or other computing devices that includes, inter alia, sufficient information to access the content. Links typically include a URL or other type of URI that provides a name and a logical network path to a digital object embodying the content.

For the purposes of the present disclosure, the term “psychographic” or “psychographic variables” should be understood to refer to variables, factors and/or constants that characterize personality, values, attitudes, interests, or lifestyles. Psychographic variables can also be called IAO variables (for Interests, Activities, and Opinions). Psychographic variables can be contrasted with, for example, demographic variables (such as age and gender), and behavioral variables (such as usage rate or loyalty).

In various embodiments, the present disclosure relates to systems and methods for developing titles for content that are fine-tuned to the psychographics of users to which titles for such content are presented. A particular content item may contain content that is of potential interest to various users, however, each user has his or her own world-view and attitudes, and a title that is slanted to a user's world-view and/or attitude is more likely to attract the user's attention.

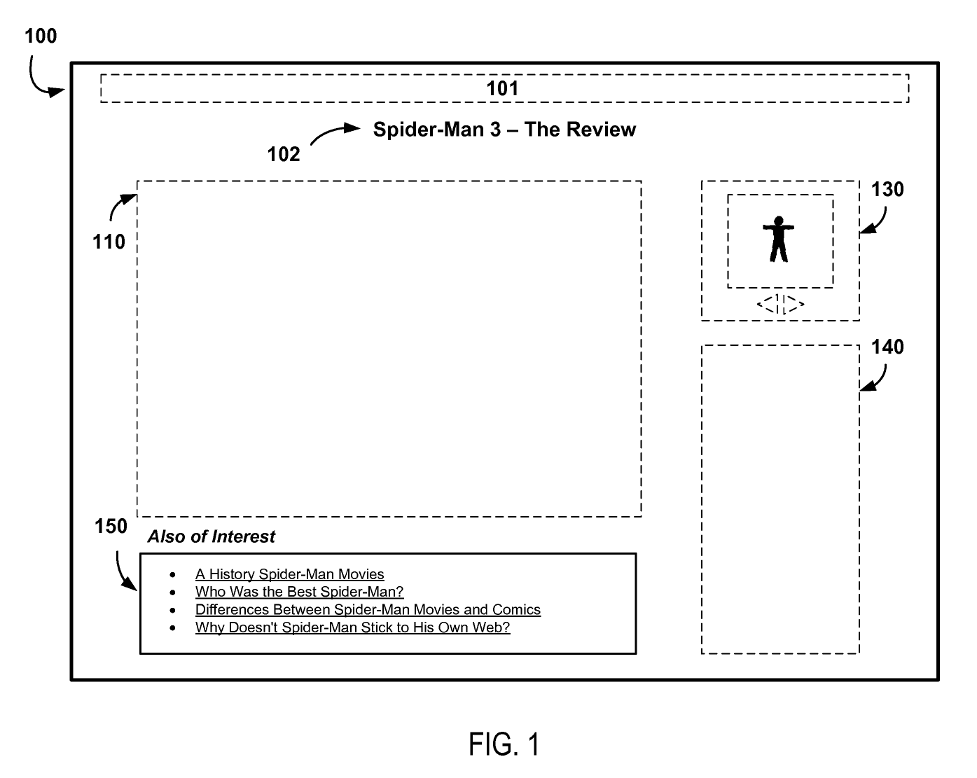

FIG. 1 shows an illustrative web page 100 where a user is viewing a review 102 of “Spiderman 3”. The use may have reached the webpage 100 from, for example, search engines and links from around the Internet. The webpage 100 can include, for example, a title 102 of the review, review text 110, a video 130 of the review, advertisements 140 and related content 150 (e.g. recommended content).

Absent any other inducement, a visitor to the website might read the review and then leave the webpage. In an embodiment, the website owner may wish the visitor to stay longer on the webpage 100 and consume more content, thereby generating increased revenues for the website owner. In an embodiment, the website owner adds links to related content 150 to the webpage. In an embodiment, these are links to other pages on the same website. In an embodiment, such a webpage could include titles 150 such as
A History Spider-Man Movies
Who Was the Best Spider-Man?
Differences Between Spider-Man Movies and Comics
Why Doesn't Spider-Man Stick to His Own Web?

In this case, the website owner is offering four additional pieces of content for the visitor to click on. In an embodiment, each of those web pages in turn links to other pages on the website as well, in a continual effort to retain the visitor on the site (e.g., to view additional content or advertising, or to receive services). In an embodiment, links may be chosen using one or more of at least three different (but potentially related) models. First the links can be chosen to be contextual, that is, relevant to the page that the visitor is presently on. In the illustrated embodiment, the links 150 are contextual in that they relate to Spiderman.

Second, the links may be chosen based, at least in part, on demographic variables. Thus, links may be chosen based on the demographic characteristics of the visitor (e.g., whether they are male or female, low or high income, where their IP address is from, and so forth. In the illustrated embodiment, the links 150 may be based, at least in part, on the demographics of the user, for example, it may be determined that only male users over the age of 30 are interested in “Differences Between Spider-Man Movies and Comics”.

Third, the links may be chosen based, at least in part, on the popularity of the links. Thus, in various embodiments, the most popular links from a website are chosen as such links relate to items of general and known interest.

However, a distinction must be drawn between a content item and its title. Content may include hundreds or thousands of words of text and may additionally include embedded images and/or videos. Links to such content, however, are represented by titles on webpages. Such titles are often short and concise. As such, such titles typically cannot fully represent the nuances of the content to which they relate. As such, then, multiple titles may be assigned to a given content item, each title reflecting a perspective on the content item. Furthermore, a given content item on the Internet may be referenced by multiple hyperlinks.

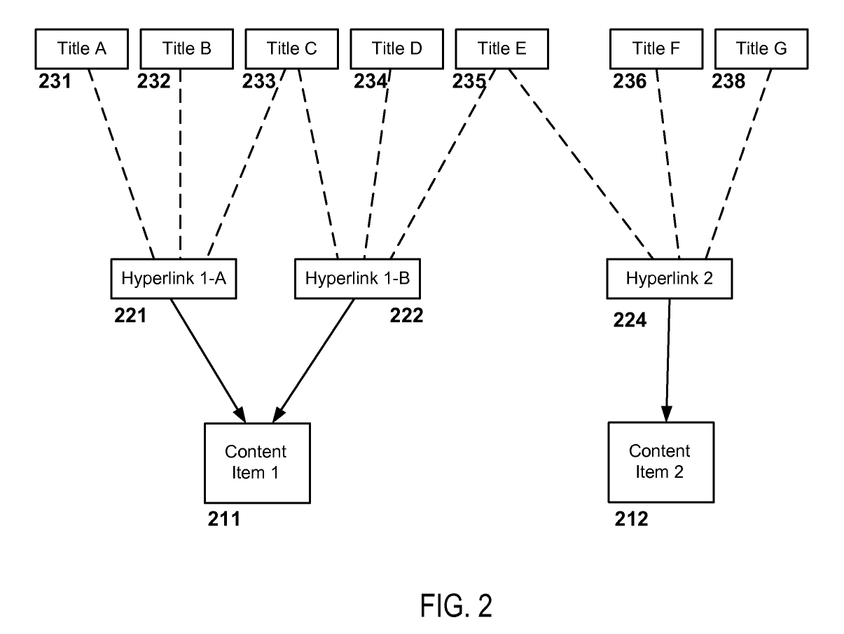

FIG. 2 illustrates an embodiment of the relationship between content items 211 and 212, links to such content 221, 222 and 224, and the titles 231-238 to which they relate. In the illustrated embodiment, there are two content items 211 and 212. Such content items may reside on the same, or different websites. Such content items 211 and 212 may include, without limitation, text, images and/or multimedia content. Such content items 211 and 212 may be linked to by one or more hyperlinks 221, 222 and 224. Such hyperlinks 221, 222 and 224 may be referenced in one or more webpage on the same, or different website. Each hyperlink 221, 222 and 224 is displayed on webpage using one or more titles 231-238.

A given hyperlink, for example hyperlink 221, may be associated with more than one title, as in the case of hyperlink 221, titles 231-233. Each title 231-233 may represent a different perspective on the content item 211 to which it relates. The 231-233 titles may be displayed on one or more webpages of a given website, and/or may be displayed on different websites. In an embodiment, more than one title 231-238 may be displayed on a single webpage relating to a content item 211 and 212.

In an embodiment, the title 231-238 is customized to the user viewing the webpage. In an embodiment, the title 231-238 is chosen to be a title that is more likely to appeal to a user based on the user's psychographic variables. In an embodiment, the content itself may, additionally or alternatively, be selected based on the user's psychographic variables. The present disclosure relates, inter alia, to selecting titles based on user's psychographic variables.

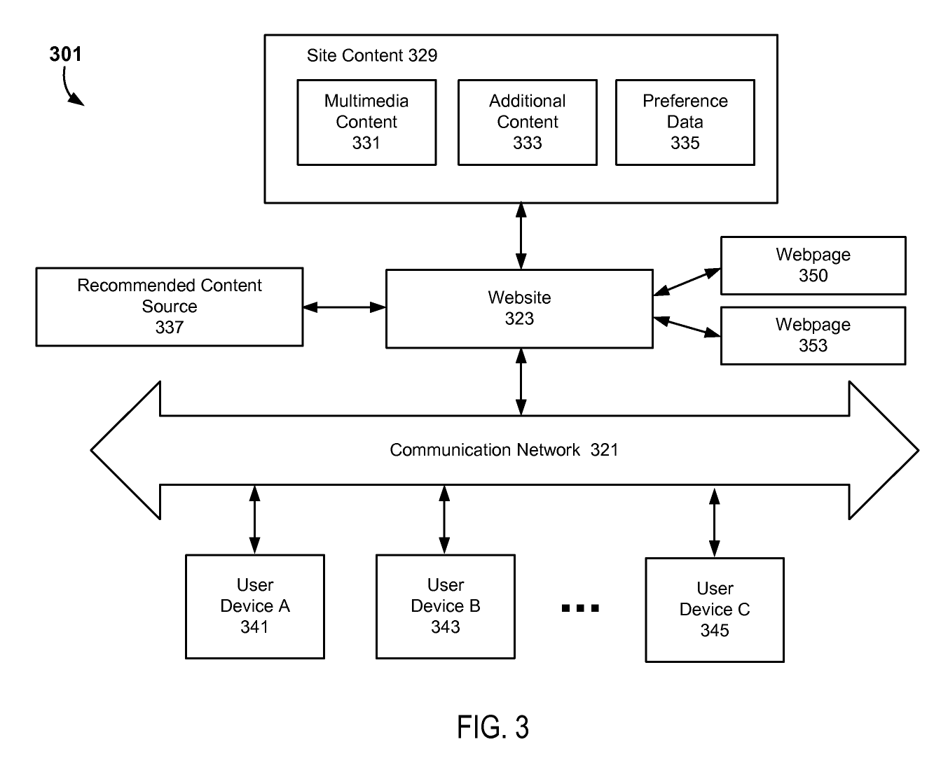

FIG. 3 shows a system to present content and titles (such as described above) to a user according to one embodiment. In FIG. 3, the user devices (e.g., 341, 343 . . . 345) are used to access a website 323 over a communication network 321. Website 323 presents various forms of content on webpages 350, 352. The website 323 may include one or more web servers (or other types of data communication servers) to communicate with the user devices (e.g., 341, 343 . . . 345).

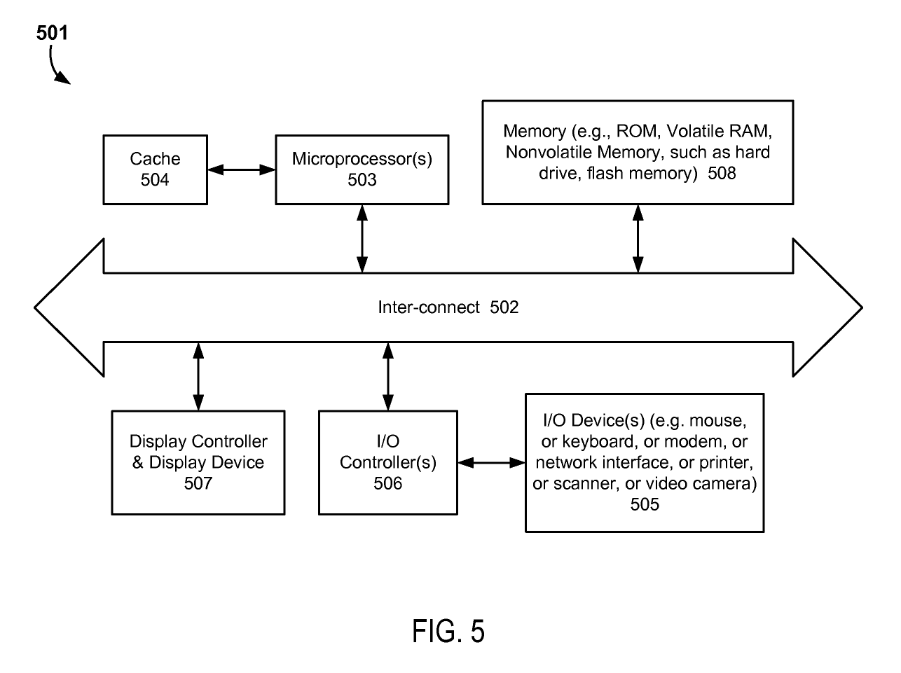

A website 323 is connected to a data storage facility to store site content 329, such as multimedia content 331, additional content 333, preference data 335, etc. Webpage 350 may, for example, display content associated with reviews of movies (e.g., a new Spider-Man movie) such as shown in FIG. 1. The website 323 may additionally obtain recommended content from a recommended content source 337 such as, for example, a recommended content platform as shown in FIG. 5, discussed below. In an embodiment, the recommended content platform is a recommended content platform such as that described in U.S. patent application Ser. No. 13/285,874, filed Oct. 31, 2011, entitled “SYSTEMS AND METHODS FOR RECOMMENDED CONTENT PLATFORM”.

Although FIG. 3 illustrates an example system implemented in client server architecture, embodiments of the disclosure can be implemented in various alternative architectures. For example, the website can be implemented via a peer-to-peer network of user devices, where the content and/or titles are shared via peer-to-peer communication connections. For example, some functions may be implemented in the individual user devices, instead of running on one or more centralized servers.

In some embodiments, a combination of client server architecture and peer-to-peer architecture can be used, in which one or more centralized servers may be used to provide some of the information and/or services and the peer-to-peer network is used to provide other information and/or services. Thus, embodiments of the disclosure are not limited to a particular architecture.

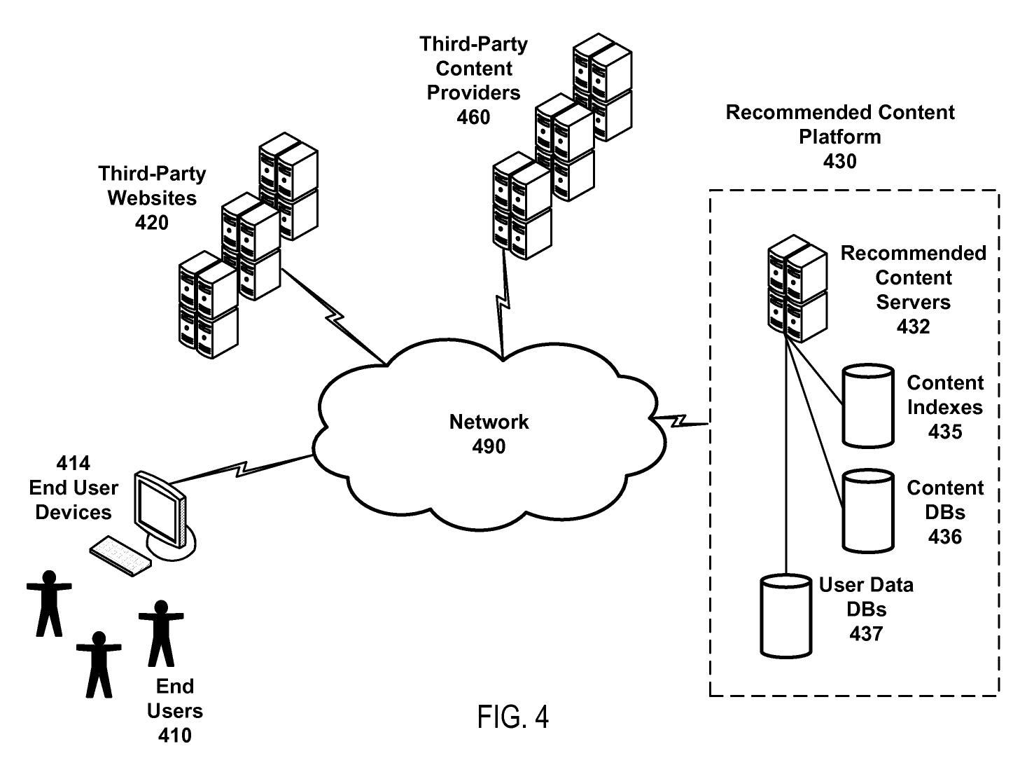

FIG. 4 illustrates a high-level view of components of one embodiment of systems and networks for implementing a recommended content platform and provide recommended content services to websites and end-users.

In an embodiment, end-users 410 access various third-party 420 websites over a network 490 such as the Internet. Such third-party 420 websites could comprise any type of website of interest to the users 410 such as, for example, news websites, topical websites and social networking websites. In one embodiment, one or more webpages within such websites 420 obtain links for recommended content, as well as content source for such links, from a recommended content platform 430.

In an embodiment, such links may be directed to content residing on one or more content databases 436 associated with the recommended content platform 430. In an embodiment, such links may additionally or alternatively be directed to content residing on third-party content provider systems 460. In an embodiment, at least some of the links include titles having one or more psychographic tags.

In an embodiment, third-party websites 420 request links to recommended content on behalf of end-users 410. In various embodiments, such requests for links to recommended content may be based on the content of a webpage viewed by users 410, or alternatively or additionally, be based on data associated with the users, for example, data stored on the users' 410 devices 414 and/or data associated with the user stored on user data databases 437 associated with the user.

In an embodiment, the recommended content platform 430 obtains content from one or more third-party content providers 460. In an embodiment, the content obtained from the third-party content providers 460 can include content specifically authored for the provider of the recommended content platform 430. In an embodiment, the content obtained from the third-party content providers 460 can include content that was not specifically authored for the provider of the recommended content platform 430, and which, furthermore, may be publicly accessible, for example, newspaper articles of a major newspaper.

In an embodiment, the recommended content platform 430 stores the content provided by third-party content providers 460 on the content databases 436. In an embodiment, the recommended content platform 430 additionally or alternatively only stores links to content provided by third-party content providers 460 on the content databases 436. In an embodiment, the recommended content platform 430 builds and maintains one or more content indexes 435 that index the content, for example, using keywords or key phrases that describe or characterize the content.

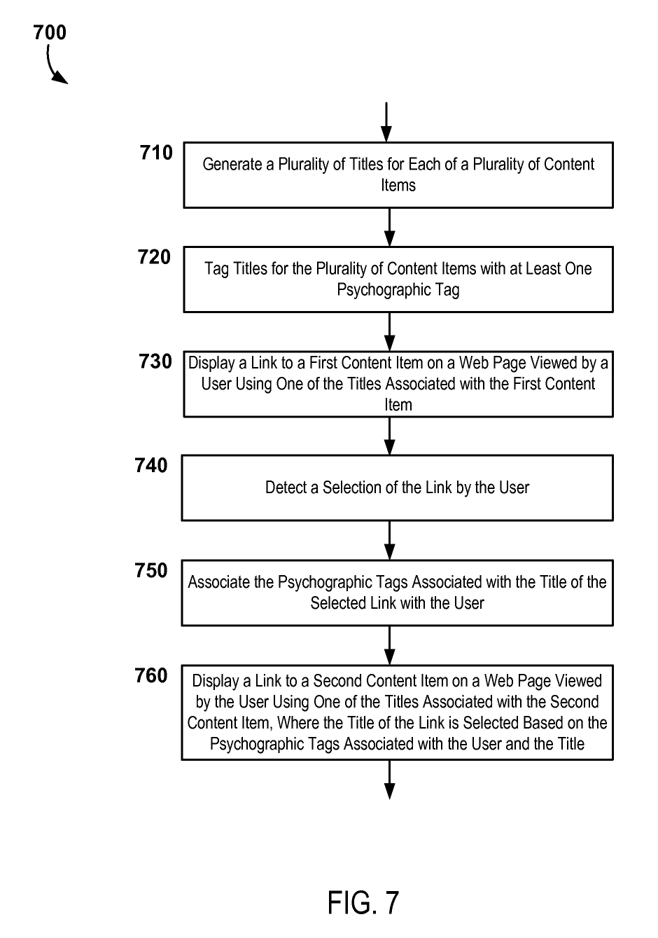

In an embodiment, the recommended content platform 430 creates multiple titles for at least some content items and tags such titles with various tags, including psychographic tags. In an embodiment, the recommended content platform 430 creates multiple titles for at least some content items and tags such titles using the process described below with reference to FIG. 7. In various embodiments, such multiple titles and title tags may be stored in the content indexes 435 or the content databases 436, or alternatively, in a separate title database (not shown) associated with the recommended content platform 430.

In an embodiment, the recommended content platform 430 detects when users 410 click on links supplied by the recommended content platform 430. In an embodiment, when a link that a user 410 clicks includes a title with psychographic tags, the recommended content platform 430 associates such psychographic tags with the user. In an embodiment, the recommended content platform 430 associates such psychographic tags with the user by causing the tags to be stored on the user's device 414, for example, in a cookie. Additionally or alternatively, the tags may be stored in a user data database 437 associated with the recommended content platform 430.

In an embodiment, when the recommended content platform 430 receives a request for recommended content from a third-party website 420 on behalf of a user 410, the recommended content platform selects recommended content based on the content of the request. In an embodiment, when the recommended content platform 430 then selects a title for each selected content item. In an embodiment, recommended content platform 430 selects titles using, at least in part, psychographic tags associated with the user 410. In various other embodiments, psychographic tags may also be used to select the content itself. In an embodiment, links to the recommended content, including the selected titles, are then transmitted to the third-party website 420 for display to the user 410.

FIG. 5 shows a block diagram of a data processing system that can be used in various embodiments. While FIG. 5 illustrates various components of a computer system, it is not intended to represent any particular architecture or manner of interconnecting the components. Other systems that have fewer or more components may also be used.

In FIG. 5, the system 501 includes an inter-connect 502 (e.g., bus and system core logic), which interconnects a microprocessor(s) 503 and memory 508. The microprocessor 503 is coupled to cache memory 504 in the example of FIG. 5.

The inter-connect 502 interconnects the microprocessor(s) 503 and the memory 508 together and also interconnects them to a display controller and display device 507 and to peripheral devices such as input/output (I/O) devices 505 through an input/output controller(s) 506. Typical I/O devices include mice, keyboards, modems, network interfaces, printers, scanners, video cameras and other devices that are well known in the art.

The inter-connect 502 may include one or more buses connected to one another through various bridges, controllers and/or adapters. In one embodiment the I/O controller 506 includes a USB (Universal Serial Bus) adapter for controlling USB peripherals, and/or an IEEE-1394 bus adapter for controlling IEEE-1394 peripherals.

The memory 508 may include ROM (Read Only Memory), and volatile RAM (Random Access Memory) and non-volatile memory, such as hard drive, flash memory, etc.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a data processing system as illustrated in FIG. 5 can be used to implement the recommended content servers 432, servers and other computing devices associated with the third-party websites 323 and 420, third-party content providers 460 and/or other servers.

In one embodiment, a data processing system as illustrated in FIG. 5 can be used to implement user devices 341, 343, 345 and 414. A user device may be in the form of a personal digital assistant (PDA), a cellular phone, a notebook computer, a laptop computer, or a personal desktop computer.

In some embodiments, one or more servers of the system can be replaced with the service of a peer-to-peer network of a plurality of data processing systems, or a network of distributed computing systems. The peer-to-peer network, or a distributed computing system, can be collectively viewed as a server data processing system.

Embodiments of the disclosure can be implemented via the microprocessor(s) 403 and/or the memory 408. For example, the functionalities described can be partially implemented via hardware logic in the microprocessor(s) 403 and partially using the instructions stored in the memory 408. Some embodiments are implemented using the microprocessor(s) 403 without additional instructions stored in the memory 408. Some embodiments are implemented using the instructions stored in the memory 408 for execution by one or more general-purpose microprocessor(s) 403. Thus, the disclosure is not limited to a specific configuration of hardware and/or software.

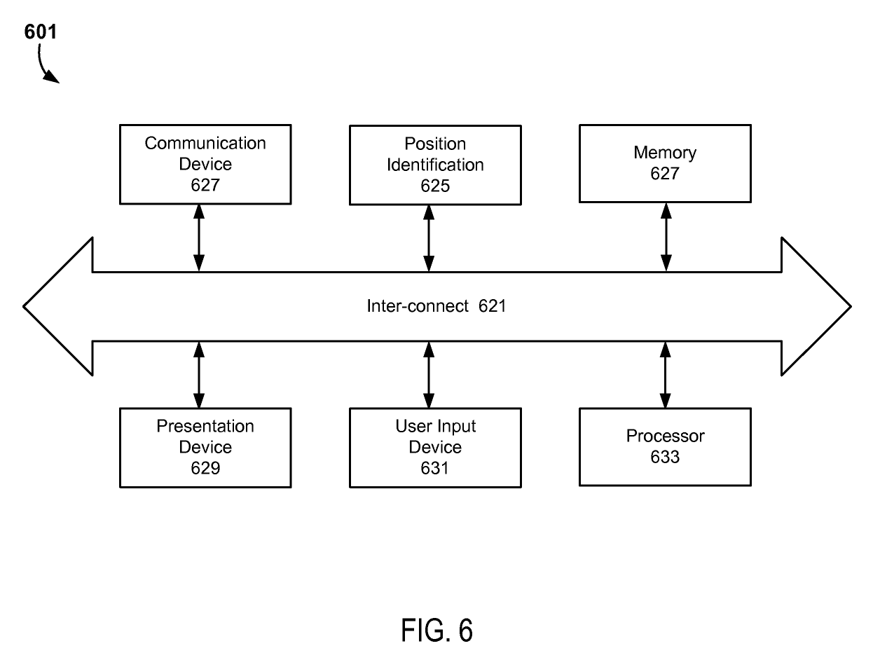

FIG. 6 shows a block diagram of a user device according to one embodiment. In FIG. 6, the user device includes an inter-connect 621 connecting the presentation device 629, user input device 631, a processor 633, a memory 627, a position identification unit 625 and a communication device 623.

In FIG. 6, the position identification unit 625 is used to identify a geographic location for user content created for sharing. The position identification unit 625 may include a satellite positioning system receiver, such as a Global Positioning System (GPS) receiver, to automatically identify the current position of the user device. In FIG. 6, the communication device 623 is configured to communicate with a website to provide user data content tagged with user-generated data. The user input device 631 may include a text input device, a still image camera, a video camera, and/or a sound recorder, etc.

In one embodiment, the user input device 631 and the position identification unit 625 are configured to automatically tag the user data content created by the user input device 631 with information identified by the position identification unit 625.

In one embodiment, a user device as illustrated in FIG. 6 can be used to implement user devices 341, 343, 345 and 414. A user device may be in the form of a personal digital assistant (PDA), a cellular phone, a notebook computer, a laptop computer, or a personal desktop computer.

FIG. 7 illustrates an embodiment of a process 700 for providing titles for content that are fine-tuned to users' pychodemographics. In various embodiments, unless specifically stated to the contrary, all of the processing in each operation of the process described below is performed by one or more servers and/or computing devices such as, for example, the recommended content servers 432 and/or user devices 414 (as applicable).

In the first operation 710 of the method, one or more servers generate a plurality of titles for each content item of a plurality of content items (e.g. newspaper articles). A content item may initially have a single title (e.g. that supplied by the author). For example, a newspaper article may have single headline and a single title, but this does not have to be true for web content. Webpages can have multiple titles and titles for a single article, and such titles could change, for example, on a daily basis. For example, in an embodiment, a given content item may have five to ten different titles for the same article.

For example, for the title “A History of Spider-Man Movies”, a number of different titles could be developed, for example:
“The Secret History of Spider-Man Movies”
“Hollywood's Eight Spider-Man Movies”
“Spider-Man History”.

For the title “Who Was the Best Spider-Man?”, a number of different titles could be developed, for example:
“Most Hated and Loved Spider-Man”
“Five Men who Played Spider-Man”
“Best Spider-Man”.

In an embodiment, titles for content are generated using any suitable combination of automated or manual processes. In an embodiment, at least some of the titles are generated using input data supplied by human editors. In an embodiment, at least some of the titles are generated using embodiments of the systems and methods described in U.S. patent application Ser. No. 12/826,524, filed Jun. 29, 2010, entitled “SYSTEM AND METHOD FOR EVALUATING SEARCH QUERIES TO IDENTIFY TITLES FOR CONTENT PRODUCTION”.

In an embodiment, titles for content are generated for new content items when such new content items are added to databases associated with a recommended content platform. Additionally or alternatively, titles for content items are periodically regenerated, for example, daily or weekly.

In the second operation of the method, one or more servers tag 720 titles for at least some of the plurality of content items with at least one psychographic tag. As noted above, psychographic tags are attributes about the title and how it is structured as to, inter alia, without limitation, what emotions the title designed to appeal to. In various embodiments, it is not, per se, a classification of category. For example, a psychographic tag could include tags that relate to:
Tone: Outrageous, teasing, fear, indignation, avoidance, motivational, inciting, curiosity, etc.
Format: Lists, instructions, tips, etc.
Descriptive: Naughty, boring, celebrity, relationships, controversy, seasonal, one-time, cute, etc.
Motives: Money, sex, ego, hunger, etc.
Structural: Monosyllabic, long title, short title, alliterative, etc.

In an embodiment, there is a partial tagging of the title. In various other embodiments, there is no limit to the number of psychographic tags that could be applied to a title, the number of different titles that can be created, and the number of alternate titles that can be created. In an embodiment, these limits may vary by the size of the website in question and the amount of traffic ‘lift’ or increase the additional titles and psychographic tags titles could add.

In an embodiment, psychographic tags for titles are generated using any suitable combination of automated or manual processes. In an embodiment, at least some of the psychographic tags are generated using input data supplied by human editors. In an embodiment, at least some of the psychographic tags are generated using embodiments of the systems and methods described in U.S. patent application Ser. No. 12/828,200, filed Jun. 30, 2010, entitled “RULE-BASED SYSTEM AND METHOD TO ASSOCIATE ATTRIBUTES TO TEXT STRINGS”.

In an embodiment, psychographic tags for titles are generated for new content items when such new content items are added to databases associated with a recommended content platform. Additionally or alternatively, psychographic tags for titles are generated for newly generated titles for previously tagged content items when such new titles are generated. Additionally or alternatively, psychographic tags for titles for content items are periodically regenerated, for example, daily or weekly. In various other embodiments, titles may additionally be tagged with tags that are not psychographic tags, for example, keywords that describe the content of the content item associated with the title. In an embodiment, titles and tags are stored on one or more databases associated with a recommended content platform in association with the content items to which they relate.

In the third operation 730 of the method, in response to a first request for suggested content from a user that matches a first one of the plurality of content items, one or more servers cause a link to the first content item to be displayed on a web page viewed by a user using one title of the plurality of titles associated with the first content item.

In an embodiment, the first request for content is received from a website hosting the webpage viewed by the user. In an embodiment, the request can comprise any selection criteria that can be used to select content items including, without limitation, any keyword or combination of keywords. In an embodiment, the request for suggested content is received via a widget embedded in the webpage such as, for example, the widgets described in U.S. patent application Ser. No. 13/285,874, filed Oct. 31, 2011, entitled “SYSTEMS AND METHODS FOR RECOMMENDED CONTENT PLATFORM.”

In one embodiment, the title used to display the link is selected from a plurality of titles associated with the first content item. In an embodiment, where a user's psychographic characteristics are not known (e.g. the user's preferences for tiles/content having a particular psychographic slant), the title is selected randomly. In various other embodiments, the title is selected using any methodology of the website owner's choosing, for example, based on, at least in part, user preferences or demographics, serially and so forth.

In the fourth operation 740 of the method, a selection of the link by the user is detected by one or more servers. In an embodiment, content associated with the link is then displayed to the user by a recommended content platform or a third-party website. In an embodiment, the user's selection of the link, as well as the title associated with the link, the tags associated with the title and/or the content item associated with the link are stored on one or more databases associated with the recommended content platform. Additionally or alternatively, the user's selection of the link, as well as the title associated with the link, the tags associated with the title and/or the content item associated with the link are stored on the user's device (e.g. an activity log).

In the fifth operation 750 of the method, one or more servers associate psychographic tags associated with the title of the link with the user. In an embodiment, when the user clicks on the link, the servers store the tags associated with the link, including, without limitation, psychographic tags, or their numeric representation, in association with the user in one or more databases associated with the recommended content platform. Additionally or alternatively, when the user clicks on the link, the servers store the tags associated with the displayed title, including, without limitation, psychographic tags, or their numeric representation in association with the user with a third-party website, for example, a social networking website of which the user is a member.

In an embodiment, when the user clicks on the link, the servers cause the user device to store the tags associated with the link, including, without limitation, psychographic tags, or their numeric representation, to the user's device, for example, a hard drive on the user's device. Additionally or alternatively, when the user clicks on the link, a process on the user device, for example, a widget embedded in the webpage or a tool bar, automatically stores the tags associated with the link, including, without limitation, psychographic tags, or their numeric representation, to the user's device, for example, a hard drive on the user's device.

In the sixth operation 760 of the method, in response to a second request for suggested content from a user that matches a second one of the plurality of content items, one or more servers cause a link to the second content item to be displayed on a web page viewed by the user, such that the link is displayed using one title of the plurality of titles associated with the second content item, where the title is selected, at least in part, based on psychographic tags associated with the user.

In an embodiment, the second request for content is received from a website hosting the webpage viewed by the user. In an embodiment, the request can comprise any selection criteria that can be used to select content items including, without limitation, any keyword or combination of keywords. In an embodiment, the request for suggested content is received via a widget embedded in the webpage such as, for example, the widgets described in U.S. patent application Ser. No. 13/285,874, filed Oct. 31, 2011, entitled “SYSTEMS AND METHODS FOR RECOMMENDED CONTENT PLATFORM.”

In one embodiment, the title used to display the link is selected from a plurality of titles associated with the second content item based on psychographic tags associated with the user. In an embodiment, psychographic tags associated with the user are retrieved from the appropriate source such as, for example, databases associated with the recommended content platform, a third party website or the user's device. In an embodiment, the psychographic tags associated with the user are then matched to psychographic tags associated with each of the plurality of titles for the second content item. Where at least a threshold number of psychographic tags associated with the user matches psychographic tags associated with one of the titles for the second content item, the title is selected and used in the display of the link.

In an embodiment, where more than one title is associated with a threshold number of psychographic tags that match the psychographic tags associated with the user, a title that is determined to be a best match is selected and used in the display of the link. In an embodiment, a title is deemed to be a best match if the title associated with a greater number of psychographic tags that match the psychographic tags associated with the user than any other title. In an embodiment, a title is deemed to be a best match is a title associated with a psychographic tag that matches a psychographic tag having a greater weight than any other tag.

In an embodiment, where more than one title is associated with a threshold number of psychographic tags that match the psychographic tags associated with the user and there is no best match, the title is selected randomly from among the matching titles. In various other embodiments, the title is selected from among the matching titles using any methodology of the website owner's choosing, for example, based on, at least in part, user preferences or demographics, serially and so forth.

In an embodiment, where the user selects the link associated with the second content item, one or more servers associate psychographic tags associated with the title of the link with the user as described above with reference to in the fifth operation 750 of the method. Over time, as a user selects additional links having titles with psychographic tags, such tags are associated with the user such that a detailed picture of the user's psychographic tendencies emerges. In an embodiment, where a given psychographic tag is associated with titles of more than one content item selected by the user, such tags may be given greater weight, for example, for matching purposes.

An illustrative example of the above method in operation is as follows. Suppose a user came to a website site and, at some point, clicked on a link “Hollywood's Eight Spider-Man Movies”. Suppose there were two psychographic tags associated with the title “[Numbered List]” and “[Newspaper Head]”. In response to the user clicking on the link, the tags (or their numeric equivalents) would be written to the user's computer.

The next time a list of links is shown to that user, on the same, or a different website, the list of links references an article originally titled by the author “Who Was the Best Spider-Man?”. Rather than displaying the link with a title “Who Was the Best Spider-Man?”, an alternate title is used: “Five Men who Played Spider-Man” because the alternate title's tags “[Numbered List] [Newspaper Head]” most closely match the known clicking pattern of the user.

While in this case, the psychographic tags were identical between what the user clicked on originally and the link that was shown to the user later, they need not be. Rather, the most similar links available can be selected (e.g., as determined by a correlation method and/or predefined thresholds).

Thus, in one embodiment, the method adjusts the tenor, cadence, attitude, and other factors of the headlines (or titles) a person sees on a website to the tenor, cadence, and attitude that they have responded to in the past. The style of headline or title that a person responds to is measurable, able to be determined, and can be used to create desirable headlines for them in the future. Further, in an alternative embodiment, new content may be generated (e.g., manually created or automatically generated, or assembled or selected from existing content) that is based on these selected desirable titles or headlines.

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using an Application-Specific Integrated Circuit (ASIC) or a Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a tangible machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
generating, using a computing device, a respective plurality of titles for each content item of a plurality of content items;
tagging, using the computing device, for each of at least a subset of the plurality of content items, at least one of the respective plurality of titles of the respective content item with at least one respective psychographic tag;
causing, using the computing device, a first link to be displayed to a user on a webpage of a first website in response to a first request for recommended content that matches a first one of the plurality of content items, wherein the link is displayed using a selected one title of the plurality of titles of the first one of the plurality of content items, wherein the selected one title of the plurality of titles of the first one of the plurality of content items is tagged with at least a first psychographic tag;
detecting, using the computing device, a selection of the first link by the user;
associating, using the computing device, the user with the at least a first psychographic tag.

2. The method of claim 1 further comprising:
causing, using the computing device, a second link to be displayed to a user on a webpage of a second website in response to a second request for recommended content that matches a selected second one of the plurality of content items, wherein the link is displayed using a selected one title of the plurality of titles of the second one of the plurality of content items, wherein the selected one title of the plurality of titles of the second one of the plurality of content items is tagged with at least a second psychographic tag,
wherein the selected one title of the plurality of titles of the second one of the plurality of content items is selected based on the at least a first psychographic tag and the at least a second psychographic tag.

3. The method of claim 2 wherein the selected one title of the plurality of titles of the second one of the plurality of content items is further tagged with at least a third psychographic title, the method further comprising:
detecting, using the computing device, a selection of the second link by the user;
associating, using the computing device, the user with the at least a third psychographic tag.

3. The method of claim 2 wherein the first psychographic tag and the second psychographic tag are each of a respective psychographic type selected from the list: tone, format, descriptive, motives, structural.

4. The method of claim 1 wherein associating the user with the at least a first psychographic tag comprises storing, using the computing device, a representation of the psychographic tag to a database accessible to the computing device in association with the user.

5. The method of claim 1 wherein associating the user with the at least a first psychographic tag comprises causing, using the computing device, a representation of the psychographic tag to be stored to a user device in a data storage format.

6. The method of claim 5 wherein the data storage format is a cookie.

7. The method of claim 2 wherein the first request is received from the first website in response to displaying the webpage of the first website to the user, and the second request is received from the second website in response to displaying the webpage of the second website to the user.

8. The method of claim 2 wherein the selected one title of the plurality of titles of the second one of the plurality of content items is selected where the first psychographic tag matches the at least a second psychographic tag.

9. The method of claim 2 wherein the selected one title of the plurality of titles of the second one of the plurality of content items is selected where the first psychographic tag matches the at least a second psychographic tag.

10. The method of claim 2 wherein at least two titles of the plurality of titles of the second one of the plurality of content items is tagged with a respective psychographic tag that matches the first psychographic tag and the selected one title of the plurality of titles of the second one of the plurality of content items is selected from the least two titles of the plurality of titles of the second one of the plurality of content items where the selected title is a best match.

11. The method of claim 10 wherein the selected title is a best match where the selected title is associated with a greater number of psychographic tags that match psychographic tags associated with the user than any other titles of the plurality of titles of the second one of the plurality of content items.

12. The method of claim 10 wherein the selected title is a best match where the selected title is associated with a psychographic tag that matches a psychographic tag associated with the user that has a greater weight than any other matching psychographic tag associated with the user.

13. The method of claim 2 wherein at least two titles of the plurality of titles of the second one of the plurality of content items is tagged with a respective psychographic tag that matches the first psychographic tag and the selected one title of the plurality of titles of the second one of the plurality of content items is randomly selected from the least two titles of the plurality of titles of the second one of the plurality of content items.

14. The method of claim 1 wherein selected one title of the plurality of titles of the first one of the plurality of content items is selected randomly.

15. The method of claim 1 wherein selected one title of the plurality of titles of the first one of the plurality of content items is selected using a methodology specified by an owner of the first website.

16. The method of claim 2 wherein selected one title of the plurality of titles of the first one of the plurality of content items is selected based, at least in part, on at least a third psychographic tag associated with the user.

17. A machine readable media embodying instructions for a widget embedded in a webpage, the instructions causing a data processing system to perform a method, the method comprising:
generating a respective plurality of titles for each content item of a plurality of content items;
tagging, for each of at least a subset of the plurality of content items, at least one of the respective plurality of titles of the respective content item with at least one respective psychographic tag;
causing a first link to be displayed to a user on a webpage of a first website in response to a first request for recommended content that matches a first one of the plurality of content items, wherein the link is displayed using a selected one title of the plurality of titles of the first one of the plurality of content items, wherein the selected one title of the plurality of titles of the first one of the plurality of content items is tagged with at least a first psychographic tag;
detecting a selection of the first link by the user;
associating the user with the at least a first psychographic tag.

18. The machine readable media of claim 17 further comprising:
causing a second link to be displayed to a user on a webpage of a second website in response to a second request for recommended content that matches a selected second one of the plurality of content items, wherein the link is displayed using a selected one title of the plurality of titles of the second one of the plurality of content items, wherein the selected one title of the plurality of titles of the second one of the plurality of content items is tagged with at least a second psychographic tag,
wherein the selected one title of the plurality of titles of the second one of the plurality of content items is selected based on the at least a first psychographic tag and the at least a second psychographic tag.

19. A computer system comprising:
a memory; and
at least one processor coupled to the memory to:
generate a respective plurality of titles for each content item of a plurality of content items;
tag, for each of at least a subset of the plurality of content items, at least one of the respective plurality of titles of the respective content item with at least one respective psychographic tag;
causing a first link to be displayed to a user on a webpage of a first website in response to a first request for recommended content that matches a first one of the plurality of content items, wherein the link is displayed using a selected one title of the plurality of titles of the first one of the plurality of content items, wherein the selected one title of the plurality of titles of the first one of the plurality of content items is tagged with at least a first psychographic tag;
detect a selection of the first link by the user;
associate the user with the at least a first psychographic tag.

20. The computer system of claim 19 wherein the processor is further configured to:
cause a second link to be displayed to a user on a webpage of a second website in response to a second request for recommended content that matches a selected second one of the plurality of content items, wherein the link is displayed using a one title of the plurality of titles of the second one of the plurality of content items, wherein the selected one title of the plurality of titles of the second one of the plurality of content items is tagged with at least a second psychographic tag,
wherein the selected one title of the plurality of titles of the second one of the plurality of content items is selected based on the at least a first psychographic tag and the at least a second psychographic tag.
